(19) United States
(12) Patent Application Publication
(10) Pub. No.: US 2022/0243845 A1
(43) Pub. Date: Aug. 4, 2022

(54) THREADED JOINT WITH SHOULDER PRODUCED BY ADDITIVE MANUFACTURING

(71) Applicant: VALLOUREC OIL AND GAS FRANCE, Aulnoye-Aymeries (FR)

(72) Inventor: Eric VERGER, Boulogne (FR)

(73) Assignee: VALLOUREC OIL AND GAS FRANCE, Aulnoye-Aymeries (FR)

(21) Appl. No.: 17/623,779

(22) PCT Filed: Jun. 29, 2020
(86) PCT No.: PCT/EP2020/068251

§ 371 Date: Dec. 29, 2021

(30) Foreign Application Priority Data
Jul. 1, 2019 (FR) FR1907277

(51) Int. Cl. F16L 15/00; F16L 15/08; E21B 17/042

(52) U.S. Cl. CPC F16L 15/004; E21B 17/042; F16L 15/08

(57) ABSTRACT

A tubular threaded joint for the drilling, the exploitation of hydrocarbon wells or the transport of oil and gas includes a male tubular element and a female tubular element. The female tubular element includes a female inner threaded portion and a female non-threaded portion. The male tubular element includes a male outer threaded portion and a male non-threaded portion. The male or female tubular element includes a body and an added portion by additive manufacturing that includes at least one first abutment surface.

The invention relates to steel tubular threaded components and more specifically a tubular joint comprising a shoulder produced by additive manufacturing, for the drilling, the exploitation of hydrocarbon wells or for the transport of oil and gas.

Here, “component” means any element or accessory used for drilling or exploiting a well and comprising at least one connection or connector or even threaded end, and intended to be assembled by a threading with another component in order to constitute with said other component a tubular threaded joint. The component may be for example a tubular element of relatively long length (in particular of approximately around ten metres in length), for example a tube, or else a tubular sleeve of a few tens of centimetres in length, or again an accessory of said tubular elements (hanger, cross-over, safety valve, tool joint, sub, and similar).

The tubular joints are provided with threaded ends. Said threaded ends are complementary enabling the mutual connection of two male tubular elements (Pin) and female tubular elements (Box). Therefore, there is one male threaded element and one female threaded element. The threaded ends known as premium or semi-premium generally include at least one abutment surface. A first abutment may be formed by two surfaces of two threaded ends, substantially radially oriented, configured so as to be in contact with one another at the end of the mutual screwing of the threaded ends or during compressive stresses. The abutments are generally negative angles in relation to the main axis of the connections. It is also known intermediate abutments on joints including at least two threading stages.

During the connection of a tubular threaded joint, it is frequent that greases, fluids, gases or any other similar product embed into the spaces (or spacing) that remained free after connection of the male and female threads. Said spaces may be confined or closed, for example, by metal-metal sealing surfaces in contact on one side and male and female abutment surfaces that come into contact on the other side. Said spaces may also be confined by the connection of the male and female threads on one side and of the male abutment surface that comes into contact with a female abutment surface on the other side, as in the case of semi-premium connections that do not include metal-metal sealing surfaces. Said grease poses problems of major stresses on the tubes by creating an undesirable pressure at the connections of said tubes. Said pressures may in particular cause problems of deformations, unscrewing, swelling, etc., and other undesirable effects that may embrittle the connection of the tubes that may lead to major accidents during installation or use of the tubes in the exploitation wells, drilling or even during the transport (e.g.: pipelines).

Indeed, in the case of a seal known as internal, where the female portion, having by construction a rigidity greater than same of the lip of the male portion, is opposite the lip of the male portion. The lip of the male portion then tends to deform inwardly. The radial deformation inwardly of the lip of the male portion reduces the contact pressure at the sealing surface, then making possible a leak of the fluid towards the threading and the exterior of the connection. The result may be, apart from a loss of fluid circulating inside the tubes and a reduction in productivity of the well, contamination of the fluid present outside of the tube by a fluid present inside the tube, but also a permanent deformation of the lip of the male portion. Moreover, the radial deformation of the lip may lead to leaks when the threaded joint is subject once again to high internal or external fluid pressures. Furthermore, the radial deformation of the lip may lead to losses of structural integrity during compression and catching of tools moved internally in the tubes.

It is known from prior art the solution proposed by patent US 2010/0301603 A1 relating to an invention in the field of premium threaded tubular connections used to connect steel tubes, such as drillpipe tubes, for example interior or exterior. It is disclosed in particular that the high pressure fluid (liquids or gases) seal results from mutual radial interference of the sealing surfaces. The intensity of the radial interference is a function of the relative axial positioning of the male and female threaded elements and is therefore defined by abutment of said elements by screwing abutments. The aim of said document is to improve the seal of the threaded tubular joint, and in particular of the tubular threaded joint in the ready-to-use structure thereof. Said document proposes as solution to arrange a leak concavity in one of the male or female threaded portions thereof in order to place a chamber formed between the distal portion of the lip and the corresponding surface of the other threaded portion in communication with the interior of the joint.

However, within the scope of said document the arrangement of the leak concavity is done by means of direct drilling of the tube, for example by turning.

The solution of a “direct” drilling type intervention in a tubular element or a portion of said tubular element already preconceived or produced has a certain number of drawbacks. The drilling dimensions are inevitably significant, they may impair the integrity of the lip and increase the risk of lamination. Moreover, a direct abutment surface machining type intervention solution generates cutting elements at the surface of the leak concavity. In addition, the production of a concavity on an abutment surface reduces the mechanical torque permitted by said abutment surface and increases the risk of seizing. Finally, generating a leak concavity creates an additional and undesirable concentration of stress around said leak concavity. Machining difficulties are added to all of said drawbacks specific to the consequences of direct arrangement of a leak concavity, namely also that the fact of generating a leak concavity by drilling proves to be time-consuming, in particular by increasing the production cycle time and that it concerns a method difficult to control justifying high production costs.

It is known from prior art patent WO2013108931 that discloses a connector assembly for interconnecting tubular elements. Said document discloses a plurality of passages arranged in the abutment surface

Therefore, direct drilling has a plurality of drawbacks, namely of reducing the permissible torque for example in the order of −10% due to a substantial loss of material. A problem of additional stresses in the material of the connections due to the diameters of the channels produced by drilling that are high. Also, machining along a complex abutment surface of said type of channel makes it necessary to adopt a cutting tool trajectory that damages the cutting tool and increases the risk of creating burrs related to the cutting of the material, increasing the risk of seizing.

The aim of the present invention is to solve the problems of the prior art cited, by producing an added portion by additive manufacturing.

Therefore, the invention consists of a tubular threaded joint (1) for the drilling, the exploitation of hydrocarbon wells or the transport of oil and gas comprising a male tubular element (2) and a female tubular element (3), the female tubular element (3) comprising a female inner threaded portion (5) and a female non-threaded portion (6), the male tubular element comprising a male outer threaded portion (7) and a male non-threaded portion (8), characterised in that the male (2) or female tubular element (3) comprises a body (4) and an added portion (9) by additive manufacturing that comprises at least one first abutment surface.

According to one embodiment, the tubular threaded joint (1) wherein said first abutment surface is an inner (10a) or outer male abutment surface (10b), or an inner (11a) or outer female abutment surface (11b), said inner or outer male abutment surface being capable of coming into contact with a corresponding female abutment surface, characterised in that the male non-threaded portion (8) or the female non-threaded portion (6) comprises at least one inner (12a) or outer lip (12b) added by additive manufacturing.

According to one embodiment, the tubular threaded joint is characterised in that the added portion (9) is produced by additive manufacturing by hardfacing, by electron beam melting, by metal laser powder bed fusion or selective laser melting, by selective laser sintering, by direct metal deposition or “Direct Energy Deposition”, by Binder Jetting Deposition or Laser Projection Deposition, by wire arc additive manufacturing deposition.

According to one embodiment, the tubular threaded joint (1) is characterised in that the added portion has a hardness greater than the hardness of the body (4) over at least 1 mm of depth.

According to one embodiment, the tubular threaded joint (1) is characterised in that the added portion has a friction coefficient greater than the body (4).

According to one embodiment, the tubular threaded joint (1) is characterised in that the added portion (9) comprises a metal chosen from alloyed, highly alloyed steels, cupro-nickel alloy.

According to one embodiment, the tubular threaded joint (1) is characterised in that each of the male (2) and female threaded elements (3) have a frustoconical or toric metal-metal sealing surface (15) on one side and on the other side the contact between the male (10a) and female abutment surfaces (11a) thus delimiting a closed space (13).

According to one embodiment, the tubular threaded joint (1) is characterised in that the added portion (9) comprises at least one channel (17).

According to one embodiment, the tubular threaded joint (1) is characterised in that the channel (17) extends from a surface delimiting a male closed space (14a) or a surface delimiting a female closed space (14b) up to a male inner lateral surface (18a) or a female inner lateral surface (18b) or up to a male outer lateral surface (19a) or a female outer lateral surface (19b).

According to one embodiment, the tubular threaded joint (1) is characterised in that the channel (17) is at a predetermined distance of at least 2 mm from the abutment surface in contact in the assembled state of the joint.

According to one embodiment , the tubular threaded joint (1) is characterised in that the channel (17) is at a predetermined distance of at least 2.5 times the diameter of the circumscribed circle of a section of the channel in relation to the abutment surfaces in contact in the assembled state of the joint.

According to one embodiment, the tubular threaded joint (1) is characterised in that the channel (17) extends on the surface of the male or female abutment.

According to one embodiment, the tubular threaded joint (1) is characterised in that the channel (17) is located in the added portion in such a way that same leads on the one hand into the closed space (13) close to the abutment surface and leads on the other hand towards a lateral surface.

According to one embodiment, the tubular threaded joint (1) is characterised in that a channel (17) extends linearly, axially, radially or in a combination thereof.

According to one embodiment, the tubular threaded joint (1) is characterised in that the depth of the added portion comprising the channel (17) corresponds to at least 4 times the circumscribed diameter of the section of the channel.

The invention also includes a method for producing the added portion by additive manufacturing according to the following description:

A method for obtaining a tubular threaded joint in that the added portion (9) is produced by a method chosen from the hardfacing methods, the electron beam melting methods, the metal laser powder bed fusion or selective laser melting methods, the selective laser sintering methods, the direct metal deposition or “Direct Energy Deposition” methods, the Binder Jetting Deposition or Laser Projection Deposition methods, the wire arc additive manufacturing deposition methods.

For example, tests have been carried out with Fero 55 type materials and stellite with a direct metal deposition method.

Alternatively, the added portion (9) can be produced with cupro-nickel alloy or microalloyed steel type materials by using for example a “Wire arc” additive technique.

Other features and advantages of the invention will become apparent upon examination of the following detailed description, and of the appended drawings.

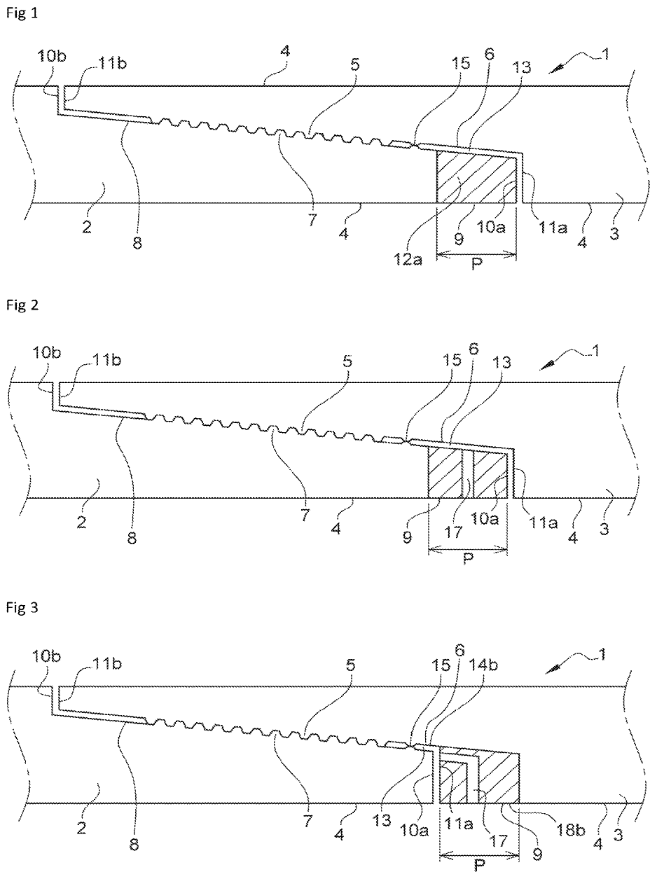

FIG. 1 schematically describes, in a longitudinal sectional view, a tubular threaded joint according to a first embodiment wherein the added portion of the male tubular element is produced by additive manufacturing.

FIG. 2 schematically describes, in a longitudinal sectional view, a tubular threaded joint according to one variation of the first embodiment wherein the added portion of the male threaded tubular element comprises a channel in depth.

FIG. 3 schematically describes, in a longitudinal sectional view, a tubular threaded joint according to a second embodiment, wherein the female abutment is produced by additive manufacturing and comprises a channel located in the added portion.

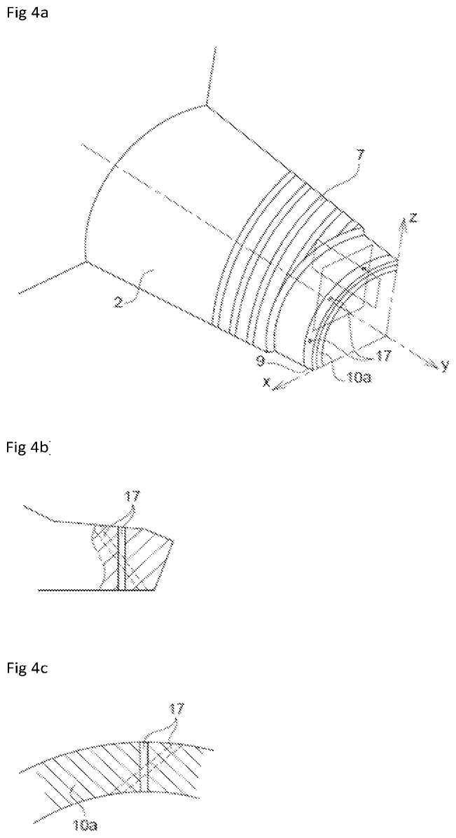

FIG. 4a schematically shows, in perspective, a tubular threaded joint according to the invention.

FIG. 4b schematically describes, in a view according to the plane (yOz), arrangements of a channel in the added portion of a male tubular element.

FIG. 4c schematically describes, in a view according to the plane (xOz), arrangements of a channel at a lip of a male element in accordance with the invention.

FIG. 4d schematically describes, in a view according to the plane (xOz), arrangements of a channel at a lip of a female element in accordance with the invention.

FIG. 5 schematically describes, in a longitudinal sectional view, a tubular threaded joint according to the invention wherein the outer female abutment surface comprises an added portion produced by additive manufacturing.

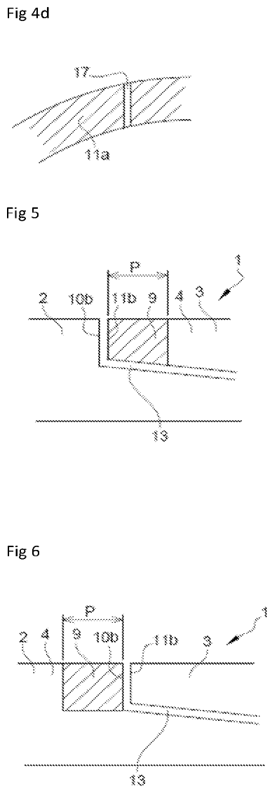

FIG. 6 schematically describes, in a longitudinal sectional view, a tubular threaded joint according to the invention wherein the outer male abutment surface comprises an added portion produced by additive manufacturing.

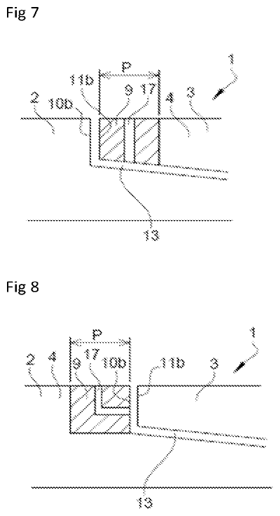

FIG. 7 schematically describes, in a longitudinal sectional view, a tubular threaded joint according to one variant in FIG. 5 wherein the added portion produced by additive manufacturing comprises a channel.

FIG. 8 schematically describes, in a longitudinal sectional view, a tubular threaded joint according to one variant in FIG. 6 wherein the added portion produced by additive manufacturing comprises a channel.

The appended drawings may not only serve to complete the invention, but also to contribute to the definition thereof, if applicable. They are not limiting as to the scope of the invention.

FIG. 1 describes a tubular threaded joint (1) with an added portion (9) on a male tubular element (2). Said added portion (9) is produced by additive manufacturing and has a substantially axial depth “P”. The tubular threaded joint (1) comprises male (10a) and female inner abutment surfaces (11a) in interfering contact in the assembled state of the joint. Said abutment surfaces make it possible to create a significant screwing torque so as to prevent an undesired unscrewing and to make it possible to place under stress other functional surfaces of the joint. Said abutment surfaces in contact may establish a certain seal to liquids or gases, especially when the joint is subjected to a compressive stress. Said seal is not desired by the designer, but endured. The tubular threaded joint (1) further comprises male and female metal-metal sealing surfaces establishing a metal-metal seal (15). Said metal-metal seal (15) provides a seal in the assembled state of the joint and during the use of the joint in a wide spectrum of stresses exerted on the joint, such as internal pressure, external pressure, compressive loads, tensile forces.

It can be seen in FIG. 1 that the greases, fluids, gases or any other similar product embed into a closed space (13) defined by the metal-metal seal (15) on one side, and on the other side the male (10a) and female abutment surfaces (11a).

According to one variant of the invention, the metal-metal sealing surface (15) is absent and a seal is produced by the female (5) and male threads (7) in the screwed state. The closed space (13) is therefore delimited on the one hand by the abutment surfaces (10a, 10b, 11a, 11b) and the female (5) and male threads (7).

According to one variant of the invention, the added portion (9) is produced by additive manufacturing in such a way that the hardness is greater than or equal to same of the non-added portion, that is to say the male or female body (4).

According to another variant of the invention, the added portion (9) is produced by additive manufacturing in such a way that the friction coefficient is greater than same of the male or female body (4).

The invention also makes it possible to significantly increase the friction coefficient between the added portion by additive manufacturing and the material of the body of the corresponding tubular element, by comparing with the friction coefficient the bodies of the male and female tubular element with one another.

An increase of the friction coefficient is accompanied with an increase of the value of the screwing torque applicable during a connection of two threaded tubular elements.

The hardness depends in particular on the type of material used, but the materials may be selected in such a way that the hardness is greater in the added portion (9) in relation to the male or female body (4).

According to one aspect of the invention, the added portion (9) comprises a metal chosen from alloyed, highly alloyed steels, cupro-nickel alloy.

Advantageously, the additive manufacturing makes it possible to both very easily arrange an internal cavity, a channel or any other passageway, but also to significantly reduce, in the event of arrangement of said passageways, the losses of material in relation to a direct intervention for example by drilling as well as the production waste. Therefore, same provides the possibility of generating short and narrow passageways as opposed to that which is possible to do from the prior art, by drilling in particular.

Advantageously, the invention makes it possible to reduce costly machining operations.

Advantageously, the invention makes it possible to increase and improve the geometric complexity of the element obtained through a construction mode layer by layer.

Advantageously, a plurality of different portions, for example with a dimension, a complexity, one or more different materials, may be constructed together and at the same time, or then added during the construction.

Advantageously, a plurality of functionalities may be added with regards to a high level of personalisation.

FIG. 2 describes in a similar way to FIG. 1, a male tubular element, wherein the added portion (9) produced by additive manufacturing this time comprises a channel or any other passageway, according to diameters both controllable and more or less reduced to prevent an embrittlement of the added portion (9) due to an excessive removal of material, a channel that is too wide or too long.

Thus, the tubular threaded joint is permeable so as to reduce the risks of presence or appearance of an overpressure in a closed space of the threaded joint, confined by surfaces producing seals.

“Permeable” means any means making it possible to generate passageways produced in the end of a male or female tubular component so as to make a closed space at the connection and an external space at the connection communicate, that may result in one or more channels having a predetermined dimension.

According to one embodiment, a channel has a width or a minimum diameter of 0.2 mm.

The shapes of said channel may vary in the space according to the planes (yOz), (xOz) or (xOy).

The channel is provided at the time of the design of the added portion during the additive manufacturing of the added portion. This makes it possible to dispense with arrangement or direct drilling as well as the associated drawbacks.

According to the invention, the tubular threaded joint is characterised in that the thickness of the deposition must correspond to at least 4 times the diameter of the circumscribed diameter of the section of the channel. It is essential to respect said condition to prevent generating too high embrittlement stresses due to the channel.

Advantageously, such a deposition respecting said parameter makes it possible specifically to prevent the channel arranged by additive manufacturing from generating a too high concentration of stresses around said channel and therefore to limit the risk of lamination of material to an area close to the channel.

Advantageously, a channel arranged by additive manufacturing makes possible the diffusion between the closed space (13) and a lateral surface.

It is accepted within the scope of our invention that said lateral surface is either a male inner lateral surface, or a female inner lateral surface, or a male outer lateral surface or a female outer surface.

FIG. 3 describes in a similar way to FIG. 2, according to a second embodiment, a female tubular element, wherein the added portion (9) produced by additive manufacturing comprises a channel.

The channel is provided during the design of the added portion (9) in such a way as to connect the closed space (13) to the female inner lateral surface (18b).

Advantageously, when it is the female abutment surface that comprises a channel, the invention meets the aim of making it possible for greases, fluids, gases or any other similar embedded product to be able to escape and free up the closed space (13). Given that this time the male lip does not have a channel, the question of stresses no longer arises for the male element. It does not arise or arises much less when this concerns the female abutment surface because the channel is arranged so as to be located on the non-stressed portion (i.e. area free of strong stresses generated by the contact between abutments).

The tubular threaded joint is characterised in that the thickness of the deposition must correspond to at least 4 times the diameter of the circumscribed diameter of the section of the channel.

Advantageously, such a deposition respecting said parameter makes it possible specifically to prevent the channel arranged by additive manufacturing from generating a too high concentration of stresses around said channel and therefore to limit the risk of lamination of material to an area close to the channel.

FIGS. 4b and 4c illustrate the various possible arrangements for a channel (17) of a male tubular element (2). It is found in particular in FIG. 4b, in a view according to the plane (yOz), a channel (17) in depth of at least 0.2 mm of width, with a thickness “d” around said channel that must be greater than 2 times the diameter of the same channel.

In FIG. 4c, the channel (17) is this time at the inner (10a) or outer male abutment surface (10b) of the male tubular element (2).

FIG. 4d describes in a similar way to FIG. 4c, a channel (17) at the inner (11a) or outer female abutment surface (11b) of the female tubular element (3).

FIGS. 5 and 6 describe variants of the invention, according to a configuration mirroring FIGS. 1, 2 and 3, wherein the added portion (9) produced by additive manufacturing is located at the outer lateral portion of a tubular threaded joint (1) or at the outer female abutment surface (11b) for FIG. 5 or the outer male abutment surface (10b) for FIG. 6.

FIG. 7 describes a variant of FIG. 5 wherein the added portion (9) produced by additive manufacturing comprises a channel (17) or any other diffusion means.

FIG. 8 describes a variant of FIG. 6 wherein the added portion (9) produced by additive manufacturing comprises a channel (17) or any other diffusion means.

1-16. (canceled)

17. A tubular threaded joint for drilling, exploitation of hydrocarbon wells, or transport of oil and gas, the tubular threaded joint comprising:
a male tubular element and a female tubular element, the female tubular element comprising a female inner threaded portion and a female non-threaded portion, the male tubular element comprising a male outer threaded portion and a male non-threaded portion,
wherein the male tubular element or the female tubular element comprises a body and an added portion by additive manufacturing that comprises at least one first abutment surface, and the added portion comprises at least one channel, said channel is located in the added portion in such a way that the channel leads into a closed space close to the abutment surface and leads towards a lateral surface.

18. The tubular threaded joint according to claim 17, wherein said first abutment surface is an inner or outer male abutment surface, or an inner or outer female abutment surface, said inner or outer male abutment surface being configured to come into contact with a corresponding female abutment surface, and the male non-threaded portion or the female non-threaded portion comprises at least one inner or outer lip added by additive manufacturing.

19. The tubular threaded joint according to claim 17, wherein the added portion is produced by additive manufacturing by hardfacing, by electron beam melting, by metal laser powder bed fusion or selective laser melting, by selective laser sintering, by direct metal deposition or “Direct Energy Deposition”, by Binder Jetting Deposition or Laser Projection Deposition, by wire arc additive manufacturing deposition.

20. The tubular threaded joint according to claim 17, wherein the added portion has a hardness greater than the hardness of the body over at least 1 mm of depth.

21. The tubular threaded joint according to claim 17, wherein the added portion has a friction coefficient greater than the body.

22. The tubular threaded joint according to claim 17, wherein the added portion comprises a metal chosen from alloyed steels, highly alloyed steels, and cupro-nickel alloy.

23. The tubular threaded joint according to claim 17, wherein each of the male and female threaded elements have a frustoconical or toric metal-metal sealing surface on one side and on the other side the contact between the male and female abutment surfaces thus delimiting a closed space.

24. The tubular threaded joint according to claim 17, wherein the channel extends from a surface delimiting a male closed space or a surface delimiting a female closed space up to a male inner lateral surface or a female inner lateral surface or up to a male outer lateral surface or a female outer lateral surface.

25. The tubular threaded joint according to claim 23, wherein the channel is at a predetermined distance of at least 2 mm from the abutment surface in contact in an assembled state of the joint.

26. The tubular threaded joint according to claim 23, wherein the channel is at a predetermined distance of at least 2.5 times the diameter of a circumscribed circle of a section of the channel in relation to the abutment surfaces in contact in an assembled state of the joint.

27. The tubular threaded joint according to claim 17, wherein the channel extends on the surface of the male or female abutment.

28. The tubular threaded joint according to claim 17, wherein the channel extends linearly, axially, radially or in a combination thereof.

29. The tubular threaded joint according to claim 17, wherein a depth of the added portion comprising the channel corresponds to at least 4 times a circumscribed diameter of the section of the channel.

30. A method for obtaining a tubular threaded joint comprising:
producing an added portion by a method chosen from hardfacing methods, electron beam melting methods, metal laser powder bed fusion or selective laser melting methods, selective laser sintering methods, direct metal deposition or “Direct Energy Deposition” methods, Binder Jetting Deposition or Laser Projection Deposition methods, and wire arc additive manufacturing deposition methods.
